(19) United States
(12) Patent Application Publication
(10) Pub. No.: US 2021/0250853 A1
(43) Pub. Date: Aug. 12, 2021

(54) CELLULAR TELECOMMUNICATIONS NETWORK COMPRISING A PLURALITY OF NETWORK SLICES

(71) Applicant: BRITISH TELECOMMUNICATIONS PUBLIC LIMITED COMPANY, LONDON (GB)

(72) Inventors: Andrew CORSTON-PETRI, London (GB); Maria CUEVAS RAMIREZ, London (GB)

(21) Appl. No.: 17/250,198

(22) PCT Filed: Jun. 11, 2019
(86) PCT No.: PCT/EP2019/065212

§ 371 Date: Dec. 14, 2020

(30) Foreign Application Priority Data
Jun. 18, 2018 (EP) 18178333.3

(51) Int. Cl. H04W 48/18; H04W 16/02

(52) U.S. Cl. CPC H04W 48/18; H04W 16/02

(57) ABSTRACT

This disclosure is directed to a method in a cellular telecommunications network, and a device for implementing the method, in which one or more network nodes are configured to implement a plurality of network slices, the method including identifying requirement data indicating a network requirement for one or more metrics for a User Equipment, UE, to access a service of a service provider; identifying network slice capability data for a first and second network slice, the network slice capability data for the first network slice indicating the first network slice's capability for the one or more metrics and the network slice capability data for the second network slice indicating the second network slice's capability for the one or more metrics; comparing the requirement data to at least one of the network slice capability data for the first network slice and the network slice capability data for the second network slice; determining that the UE should access the service using the first network slice based on the comparison; and initiating a connection of the UE to the first network slice.

### PRIORITY CLAIM

The present application is a National Phase entry of PCT Application No. PCT/EP2019/065212, filed Jun. 11, 2019, which claims priority from EP Patent Application No. 18178333.3, filed Jun. 18, 2018, each of which is hereby fully incorporated herein by reference.

### TECHNICAL FIELD

The present disclosure relates to a cellular telecommunications network.

### BACKGROUND

A conventional cellular telecommunications network used dedicated hardware components that performed specific tasks. This gave network operators fine control over its infrastructure such that it could be carefully planned and deployed. However, this was also inflexible such that all parts of the infrastructure must serve all forms of services (e.g. voice, file transfer, Device-to-Device communications), rather than be tailored for providing the optimal configuration for a particular service. To address this issue, a technique called network slicing has been introduced to cellular networks.

Network slicing allows networking infrastructure to be optimized for a particular service, end-user or network operator by deploying network functions on virtualized hardware and/or customized physical hardware. This may be performed for one or more network functions across one or more nodes in the cellular network, including the radio access network, edge network and core network. In doing so, a collection of logical network functions may be grouped into a network slice which utilizes virtual machines and/or customized physical hardware on one or more nodes in the cellular network. Each network slice may then be configured (e.g. by configuring each virtual machine of the network slice) such that it is optimized for a particular use case. For example, a first network slice for an autonomous vehicle application may be configured on one or more nodes in the cellular network to deliver an ultra-high reliability and ultra-low latency service, and further network slices configured for other applications may also be run on the same nodes through further virtual machines.

In cellular networks supporting network slicing, the network is pre-provisioned with a plurality of network slices and each device (including each User Equipment, UE) can be pre-configured with the slice identifier for each of the plurality of network slices. When the UE accesses a particular service, it attaches to the appropriate network slice based on a pre-configured mapping of slice identifier to service type (e.g. video-on-demand, file transfer, VoIP, etc.). However, this solution is inflexible as all devices in the cellular network must be updated upon any change in the network slices (e.g. the addition of a new network slice), and does not scale well.

It is therefore desirable to alleviate some or all of the above problems.

### SUMMARY

According to a first aspect of the disclosure, there is provided a method in a cellular telecommunications network in which one or more network nodes are configured to implement a plurality of network slices, the method comprising: identifying network slice capability data for a first network slice, the network slice capability data for the first network slice indicating the first network slice's capability for one or more metrics; sending the network slice capability data for the first network slice to a service provider; receiving a message from the service provider permitting access to a version of the service using the first network slice; and initiating a connection of the UE to the first network slice for accessing the version of the service.

The network slice capability data for the first and second network slices may indicate that the first network slice is a higher priority network slice than the second network slice, and the comparison may compare the requirement data to network slice capability data for the first network slice.

The comparison may indicate a first matching value between the requirement data and the capability data for the first network slice and a second matching value between the requirement data and the capability data for the second network slice, and the determination may be based on the first and second matching values.

The requirement data may further indicate a weighting value for the or each metric, and the first and second matchings values may be further based on the weighting value or values.

The method may further comprise the UE sending a request message to the service provider for the requirement data; and the service provider responding to the request message from the UE with the requirement data.

The cellular telecommunications network may include a network slice manager, the method further comprising the UE sending a request message to the network slice manager for the network slice capability data, the request message identifying a property of the service.

The property of the service may be the service type, and the method may further comprise the network slice manager identifying the network slice capability data for the first and second network slice based on the service type; and the network slice manager responding to the request message from the UE with the network slice capability data for the first and second network slice, wherein the UE performs the comparison and determination based on the network slice capability data for at least one of the first and second network slice.

The property of the service may be the requirement data, and the method may further comprise the network slice manager comparing the requirement data to at least one of the network slice capability data for the first network slice and the network slice capability data for the second network slice; the network slice manager determining that the UE should access the service using the first network slice based on the comparison; and the network manager responding to the request message from the UE with the identity of the first network slice.

One embodiment provides a method in a cellular telecommunications network in which one or more network nodes are configured to implement a plurality of network slices, the method comprising: identifying requirement data indicating a network requirement for one or more metrics for a User Equipment, UE, to access a service of a service provider; identifying network slice capability data for a first and second network slice, the network slice capability data for the first network slice indicating the first network slice's capability for the one or more metrics and the network slice capability data for the second network slice indicating the second network slice's capability for the one or more metrics; comparing the requirement data to at least one of the network slice capability data for the first network slice and the network slice capability data for the second network slice; sending the network slice capability data for the first network slice to the service provider; receiving new requirement data indicating a new network requirement for one or more metrics for the UE to access the service of the service provider; and initiating a connection of the UE to the first network slice.

According to a second aspect of the disclosure, there is provided a computer program product comprising instructions which, when the program is executed by a computer, cause the computer to carry out the method of the first aspect of the disclosure. The computer program may be stored on a computer-readable data carrier.

According to a third aspect of the disclosure, there is provided a device for a cellular telecommunications network, the cellular telecommunications network having one or more network nodes are configured to implement a plurality of network slices, the device a transceiver, memory and processor adapted to cooperate to: identify network slice capability data for a first network slice, the network slice capability data for the first network slice indicating the first network slice's capability for one or more metrics; send the network slice capability data for the first network slice to a service provider; receive a message from the service provider permitting access to a version of the service using the first network slice; and initiate a connection of the UE to the first network slice for accessing the version of the service.

One embodiment provides a device for a cellular telecommunications network, the cellular telecommunications network having one or more network nodes are configured to implement a plurality of network slices, the device a transceiver, memory and processor adapted to cooperate to: identify requirement data indicating a network requirement for one or more metrics for a User Equipment, UE, to access a service of a service provider; identify network slice capability data for a first and second network slice, the network slice capability data for the first network slice indicating the first network slice's capability for the one or more metrics and the network slice capability data for the second network slice indicating the second network slice's capability for the one or more metrics; compare the requirement data to at least one of the network slice capability data for the first network slice and the network slice capability data for the second network slice; send the network slice capability data for the first network slice to the service provider; receive new requirement data indicating a new network requirement for one or more metrics for the UE to access the service of the service provider; and initiate a connection of the UE to the first network slice.

The network slice capability data for the first and second network slices may indicate that the first network slice is a higher priority network slice than the second network slice, and the comparison step may compare the requirement data to network slice capability data for the first network slice.

The comparison may indicate a first matching value between the requirement data and the capability data for the first network slice and a second matching value between the requirement data and the capability data for the second network slice, and the determination may be based on the first and second matching values.

The requirement data may further indicate a weighting value for the or each metric, and the first and second matchings values may be further based on the weighting value or values.

The device may be further adapted to: send a request message to the service provider for the requirement data; and the service provider responding to the request message with the requirement data.

The device may be a User Equipment (UE).

The device may be part of a system, wherein the system further comprises a network slice manager, the network slice manager having a transceiver, memory and processor adapted to cooperate to perform the steps of receiving a request message from a UE for network slice capability data, the request message identifying a property of the service.

The property of the service may be the service type, and the network slice manager may be further adapted to implement: the network slice manager identifying the network slice capability data for the first and second network slice based on the service type; and the network slice manager responding to the request message from the UE with the network slice capability data for the first and second network slice, wherein the UE performs the comparison and determination based on the network slice capability data for at least one of the first and second network slice.

The property of the service may be the requirement data, and the network slice manager may be further adapted to implement: the network slice manager comparing the requirement data to at least one of the network slice capability data for the first network slice and the network slice capability data for the second network slice; the network slice manager determining that the UE should access the service using the first network slice based on the comparison; and the network manager responding to the request message from the UE with the identity of the first network slice.

According to a fourth aspect of the disclosure, there is provided a method of providing a service over a cellular telecommunications network, the cellular telecommunications network having one or more network nodes configured to implement a plurality of network slices, the method comprising: specifying a requirement profile including a network requirement for one or more metrics for a UE to access a version of a service of a service provider; receiving network slice capability data for a first network slice, the network slice capability data for the first network slice indicating the first network slice's capability for one or more metrics; comparing the network slice capability data for the first network slice to the requirement profile; and sending a message to the UE permitting access to the version of the service using the first network slice.

Following receipt of the network slice capability data for the first network slice, the method may further comprise modifying the network requirement for the one or more metrics of the requirement profile based on the network capability data for the first network slice.

The requirement profile may be a first requirement profile of a plurality of requirement profiles, wherein each requirement profile of the plurality of requirement profiles may specify a network requirement for one or more metrics for the UE to access a particular version of the service of the service provider, and the method may further comprise comparing the network slice capability data for the first network slice to the plurality of requirement profiles; identifying that the first requirement profile satisfies the first network slice's capability data; wherein the message sent to the UE identifies the version of the service associated with the first requirement profile.

The method may further comprise receiving network slice capability data for a second network slice, the network slice capability data for the second network slice indicating the second network slice's capability for one or more metrics; comparing the network slice capability data for both the first and second network slice to the plurality of requirement profiles so as to determine that the first requirement profile satisfies the first network slice's capability data; and sending the message to the UE, the message identifying the version of the service associated with the first requirement profile and the first network slice.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a cellular telecommunications network of the present disclosure.

FIG. 2 is a representation of several network slices operating upon several nodes in the network of FIG. 1.

FIG. 3 is a schematic diagram of a network slice manager of the network of FIG. 1.

FIG. 4 is a schematic diagram of a service provider network element of FIG. 1.

FIG. 5 is a flow diagram of a first embodiment of a method of the present disclosure.

FIG. 6 is a flow diagram of a second embodiment of a method of the present disclosure.

### DETAILED DESCRIPTION OF EMBODIMENTS

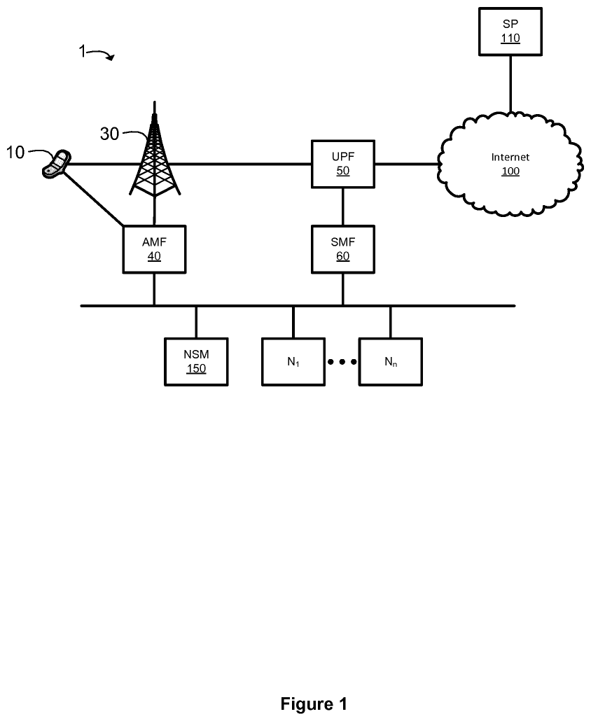

An embodiment of a cellular telecommunications network 1 will now be described with reference to FIGS. 1 to 4. The cellular telecommunications network 1 includes a first User Equipment (UE) 10, a first base station 30, an Access and Mobility Management Function (AMF) 40 for access management and mobility management of any UE connected to the first base station 30, a User Plane Function (UPF) 50 for user data packet routing and forwarding between any UE connected to the first base station 30 and a data packet network (such as the Internet 100), and a Session Management Function (SMF) 60 for management of UE sessions and policy enforcement. Several other network nodes (N₁ . . . Nₙ) are also shown as forming part of the cellular telecommunications network (which may include, for example, an Authentication Server Function (ASF), Unstructured Data Storage network Function (UDSF), etc.).

In this embodiment, the cellular telecommunications network 1 further includes a network slice manager 150, the purpose of which will become clear upon review of the following description. FIG. 1 further illustrates a service provider network element 110, which any node of the cellular telecommunications network 1 may communicate with via the Internet 100. Again, the purpose of the service provider network element 110 will become clear upon review of the following description.

The cellular communications network 1 is configured to implement network slicing. Accordingly, one or more of the first base station 30, AMF 40, UPF 50, SMF 60 (or any other node in the network 1) may implement Network Function Virtualization (NFV) architectures such that virtual machines may be established on one or more of these network elements and/or include dedicated physical hardware for a particular network slice. These virtual machines and/or dedicated physical hardware may then be tailored to a particular use case (such as for a particular service or a particular network operator) by suitable configuration. A network slice may therefore be established as a portion of the cellular telecommunications network 1 that includes all required resources (grouped together as a logical network) to serve a particular use case. In this manner, multiple mobile network operators may share the same physical infrastructure by establishing their own network slices that are isolated from any other network slice.

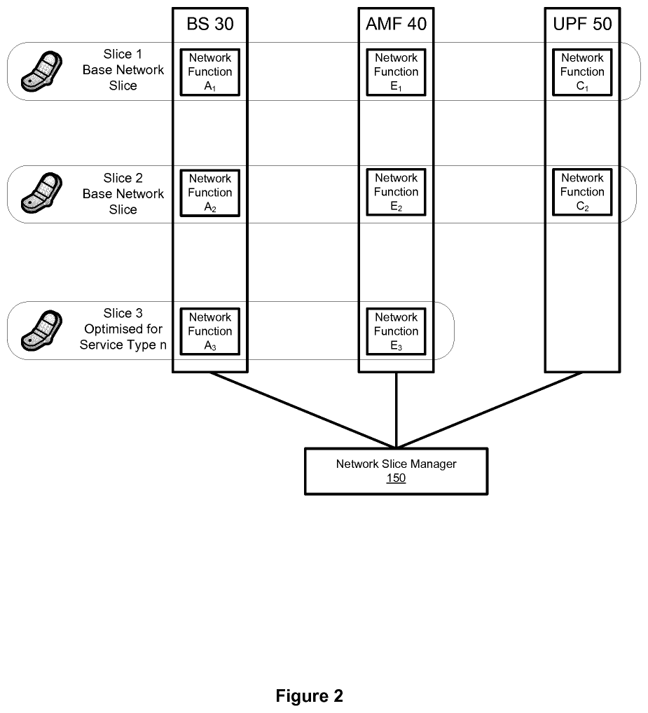

A further representation of the cellular telecommunications network 1 to illustrate these network slices is shown in FIG. 2. As network slices may be run on generalized computing hardware (rather than the dedicated infrastructure of the prior art), several nodes having generalized computing hardware for implementing one or more virtual machines on an NFV architecture are shown. These nodes may therefore implement the functions of one or more of the first base station 30, AMF 40, UPF 50, SMF 60 (or any other node) of the cellular telecommunications network 1 through Software Defined Networking (SDN) environments on any one of these virtual machines. FIG. 2 also illustrates a first, second and third network slice being established across several of these network nodes, in which each network slice includes a plurality of virtual machines established on each respective network node. In this embodiment, the first network slice is a base network slice for a first network operator, the second network slice is a base network slice for a second network operator, and the third network slice is for the first network operator and is optimized for a particular service. There are many other network slices (not shown) for both the first and second network operators.

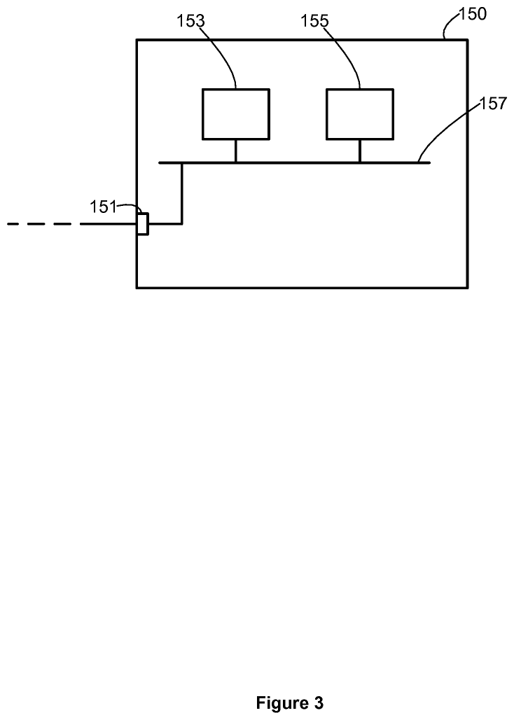

FIG. 2 also illustrates each node being in communication with the network slice manager 150, which is shown in more detail in FIG. 3 as having a first communications interface 151 (for communication with any other network node of the cellular telecommunications network 1), a processor 153 and memory 155, all connected via bus 157. In this embodiment, memory 155 stores a network slice capability database which includes a capability profile for each network slice in the cellular telecommunications network 1. In this example, the capability profile includes an identifier of the network operator owning the network slice (e.g. PLMN), a minimum bandwidth (C_{b}), an average latency (Cₗ), maximum jitter (Cⱼ), maximum packet loss (Cₚₗ), and a priority value. Table 1, below, illustrates the data stored in memory 155.

TABLE 1
Table illustrating capability data for several network slices

| | | | | | Maxi- | | |
|---|---|---|---|---|---|---|---|
| Slice | Network | | | Maxi- | mum | | |
| Identi- | Operator | Minimum | Average | mum | Packet | | Priority |
| fier | Identifier | Bandwidth | Latency | Jitter | Loss | . . . | Value |
| S¹ | P¹ | C_{b}¹ | Cₗ¹ | Cⱼ¹ | Cₚₗ¹ | . . . | 1 |
| S² | P¹ | C_{b}² | Cₗ² | Cⱼ² | Cₚₗ² | . . . | 2 |
| S³ | P² | C_{b}³ | Cₗ³ | Cⱼ³ | Cₚₗ³ | . . . | 1 |
| . . . | . . . | . . . | . . . | . . . | . . . | . . . | . . . |

The network slice manager 150 receives information on all network slices in the cellular telecommunications network 1, including network slices of different network operators. The network slice manager 150 may therefore be considered a centralized entity for storage of network slice information. In this embodiment, the network slice manager 150 transmits the capability data for all network slices that a base station may access (e.g. based on the one or more network operators that utilize that base station) to each base station in the network. In this example in which the first base station 30 is for the first network operator (Pₗ) only, the network slice manager 150 therefore transmits the capability data for the first and second network slice (S¹, S²) to the first base station 30. This data may be pushed to the first base station 30, or requested by the first base station 30, on a periodic basis.

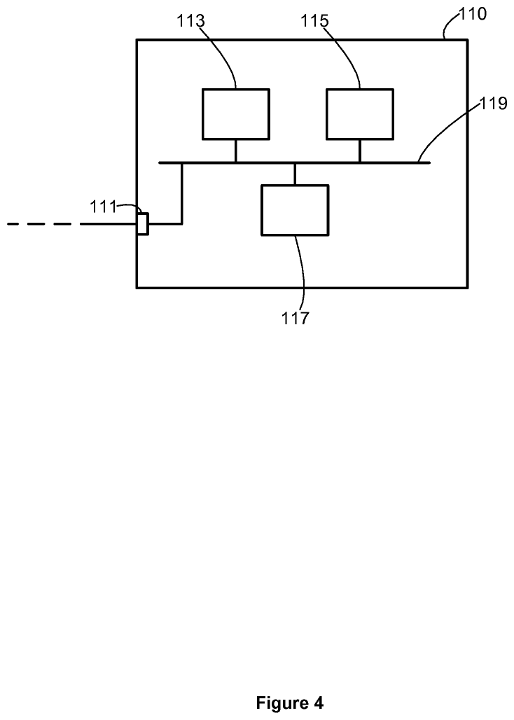

Turning back to FIG. 1, the cellular telecommunications network 1 further includes a service provider network element 110 which each element of the cellular telecommunications network 1 (e.g. the first UE 10) may communicate with via the Internet 100. In this embodiment, the service provider network element 110 provides a Virtual Reality (VR) service. The service provider network element 110 is shown in more detail in FIG. 4, which illustrates a first communications interface 111, a processor 113, a content store 115 and memory 117, all connected via bus 119. The content store 115 stores one or more items of content (e.g. different VR experiences) that may be requested by a UE and, in response, delivered via the first communications interface 111. Memory 117 stores a content requirement profile database which includes a requirement profile for each item of content in the content store 115 identifying, for example, threshold values for bandwidth (T_{b}), latency (Tₗ), jitter (Tⱼ), and packet loss (Tₚₗ). These thresholds may be set by the service provider to indicate the minimum requirements of a connection between the service provider network element 110 and another entity (e.g. the first UE 10) for the other entity to receive the item of content at a satisfactory Quality of Service (QoS). The content store 115 may store multiple versions of the same content (in which each item of content represents the same content but at a particular quality level), and the content requirement profile may identify different requirements for each version. These different versions of the same content may be identified by the same content identifier but different version identifiers.

In an enhancement, the content requirement profile may further identify weightings for each requirement, such as weighting values for bandwidth (W_{b}), latency (Wₗ), jitter (Wⱼ) and packet loss (Wₚₗ). The relevance of these weightings will become clear upon review of the following description. Table 2, below, illustrates the data stored in memory 117.

TABLE 2
Table illustrating several requirement profiles for several
items of content

| Con- | Ver- | Band- | Band- | | | | |
|---|---|---|---|---|---|---|---|
| tent | sion | width | width | Latency | Latency | Jitter | |
| Iden- | Iden- | Thresh- | Weight- | Thresh- | Weight- | Thresh- | |
| tifier | tifier | old | ing | old | ing | old | . . . |
| C¹ | V¹ | T_{b}^{1.1} | W_{b}^{1.1} | Tₗ^{1.1} | Wₗ^{1.1} | Tⱼ^{1.1} | . . . |
| C¹ | V² | T_{b}^{1.2} | W_{b}^{1.2} | Tₗ^{1.2} | Wₗ^{1.2} | Tⱼ^{1.2} | . . . |
| C² | V¹ | T_{b}^{2.1} | W_{b}^{2.1} | Tₗ^{2.1} | Wₗ^{2.1} | Tⱼ^{2.1} | . . . |
| . . . | . . . | . . . | . . . | . . . | . . . | . . . | . . . |

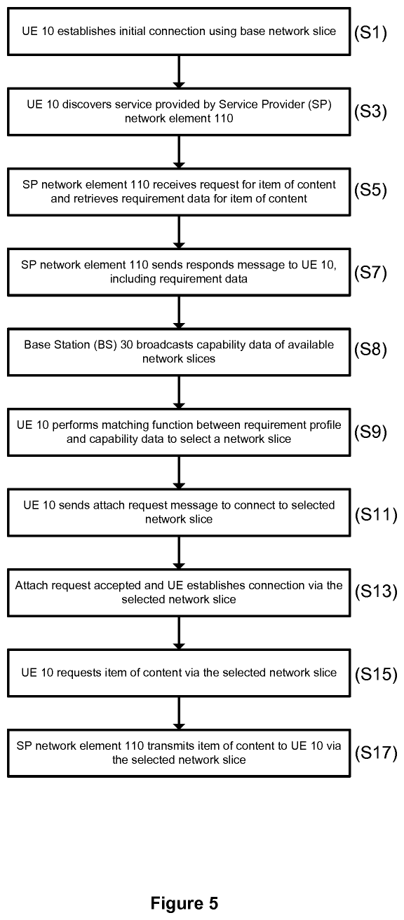

A first embodiment of a method of the present disclosure will now be described with reference to FIG. 5. In S1, the first UE 10 establishes an initial connection with the cellular telecommunications network 1 via the first base station 30. In this embodiment in which the network 1 includes the first network slice being a base network slice for the first network operator, this initial connection is established on the first network slice. Once the first UE 10 is connected via this first network slice, it may communicate with any node in the cellular telecommunications network 1 that is associated with the first network slice (such as the network slice manager 150), and may further communicate with external entities (such as the service provider network element 110) via the Internet 100.

In S3, a user operating the first UE 10 accesses a service provided by the service provider network element 110 via the first network slice and its connection to the Internet 100. In this embodiment, the service provides a User Interface (UI) to the user via which the user may select an item of content from all items of content in content store 115. In response to a selection by the user for a particular item of content, the first UE 10 prepares and sends a request message to the service provider network element 110 (which is sent via the first network slice) which identifies that particular item of content. As noted above, the content store 115 may store multiple versions of the same content but each having a different quality level).

Accordingly, the item of content being identified by the user is for a particular version of the selected content (e.g. an Ultra High Definition, UHD, version of the content), and the request message includes both a content identifier (C¹) and a version identifier (V¹).

The service provider network element 110 receives this request message and, in S5, identifies and retrieves the requirement profile for the content and version identifiers within the request. In S7, a response message is prepared, including each threshold (T_{b}^{1.1}, Tₗ^{1.1}, Tⱼ^{1.1}, Tₚₗ^{1.1}) and weighting (W_{b}^{1.1}, Wₗ^{1.1}, Wⱼ^{1.1}, Wₚₗ^{1.1}) of the requirement profile, and is sent to the first UE 10 via the first network slice. The first UE 10 stores the requirement profile for the particular item of content in memory.

In S8, the first base station 30 broadcasts (via a System Information Block (SIB) message) the capability data of all network slices (S′, S²) that the first UE 10 may access. This data, which was previously sent from the network slice manager 150 to the first base station 30, includes the minimum bandwidth for each network slice (C_{b}¹, C_{b}²), the maximum latency for each network slice (Cₗ¹, Cₗ²), the maximum jitter for each network slice (Cⱼ¹, Cⱼ²), the maximum packet loss for each network slice (Cₚₗ¹, Cₚₗ²) and the priority value for each network slice (1, 2).

In S9, the first UE 10 performs a matching function between the requirement profile of the identified content/version pair (sent from the service provider to the first UE 10) and the capability data (sent from the slice manager 150 to the first UE 10) to identify the preferred network slice from the available network slices. In this embodiment, the matching function is implemented using the following logic. In a first sub-step, the first UE 10 identifies the network slice having the highest priority (based on the priority value), which in this example is the first network slice, S¹, having priority value 1. The first UE 10 then determines if the average latency capability of S¹ is less than the average latency requirement of the requirement profile. If so, then in a second sub-step the first UE 10 determines if the maximum jitter capability of S¹ is less than the maximum jitter requirement of the requirement profile. If so, then in a third sub-step the first UE 10 determines if the minimum bandwidth capability of S¹ is greater than the minimum bandwidth requirement of the requirement profile. If so, then in a fourth sub-step the first UE 10 determines if the maximum packet loss capability of S¹ is less than the maximum packet loss requirement of the requirement profile. If all of these determinations of the first to the fourth sub-steps are positive, then network slice S¹ is selected. If any of these determinations of the first to the fourth sub-steps are negative, then the network slice S¹ is rejected. Following a rejection, the first UE 10 identifies the next network slice based on the priority value (i.e. S²) and performs the same four sub-steps. This iterative process is performed until the first UE 10 selects the highest priority network slice that satisfies all requirements of the requirement profile, which will thereafter be used for accessing and consuming the content from the service provider (as will be described below). If all network slices fail to satisfy the requirements of the requirement profile, then the first UE 10 selects the base network slice for accessing and consuming the content from the service provider.

In S11, the first UE 10 sends an attach request message to the cellular telecommunications network 1, including the network operator identifier (P¹) and slice identifier (S¹) of the selected network slice for accessing and consuming the content from the service provider. In response, in S13, the network 1 accepts the request and the first UE 10 establishes a second connection with the network via the selected network slice. In S15, the first UE 10 sends a request message to the service provider network element 110, via the selected network slice, for the item of content. In S17, the service provider network element 110 responds by sending the item of content to the first UE 10, which again will be sent via the selected network slice.

The above embodiment therefore provides a mechanism for the first UE 10 to identify and match the capabilities of currently available network slices (as advised by the network) with the current requirements of a service (as advised by the service provider). This mechanism permits evaluation of each slices' capabilities with the service's requirements based on up-to-date data, rather than one or both being static pre-provisioned data.

In the above embodiment, a matching function is used to evaluate each available network slice in priority order. However, this is non-essential and other methods of evaluating the most suitable network slice may be used. For example, the difference between the capability value and requirement value for each metric may be calculated, and a sum of all of these deltas may be used to determine a network slice eligibility value for the network slice. The network slice having the greatest eligibility value may then be selected for accessing and consuming the content from the service provider. Furthermore, the weighting values (stored in the network slice manager 150 and transmitted to the first UE 10 via the first base station 30) may be applied to each delta to modify the influence of each metric on the network slice eligibility value.

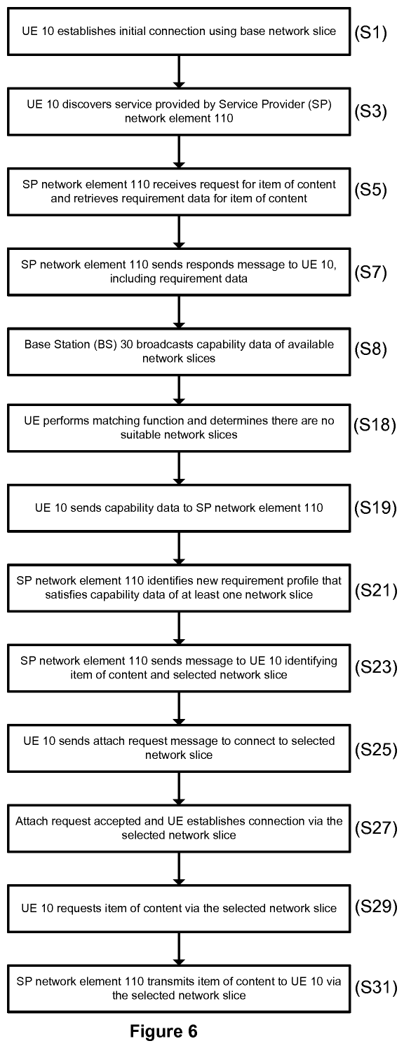

A second embodiment of a method of the present disclosure will now be described with reference to FIG. 6. This second embodiment utilizes S1 to S8 of the first embodiment, such that the first UE 10 receives capability data for each available network slice from the network slice manager 150 and further receives a requirement profile for the requested service from the service provider network element 110. In S18, the first UE 10 performs the matching function between these capabilities and requirements and determines that none of the network slices identified in the response message from the network slice manager 150 satisfy the requirements. Instead of implementing the solutions outlined above (e.g. using the base network slice or finding the best match based on an eligibility algorithm), the first UE 10 sends, in S19, the capability data for the network slices to the service provider network element 110. In this embodiment, the first UE 10 sends the capability data for the top-5 highest priority network slices (based on the network slices' priority values) to the service provider network element 110. However, the skilled person will understand that this is non-essential, and the first UE 10 may send the data for all network slices, or a set of network slices using an alternative limitation (e.g. based on a range of parameters).

In response, in S21, the service provider network element 110 identifies a new requirement profile for the content based on the received capability data from the first UE 10. In this second embodiment, the service provider network element 110 identifies this new requirement profile by identifying another version of the same content that has a corresponding requirement profile that satisfies the capability data of at least one of the network slices. For example, the service provider network element 110 may identify a High Definition, HD, version of the same VR content and determine whether the capability data of at least one of the network slices satisfies the requirement profile for that version. If so, then that version is selected. If not, then the service provider network element 110 may identify a Standard Definition, SD, version of the same content and determine whether the capability data of at least one of the network slices satisfies the requirement profile for that version. This process repeats iteratively until the service provider network element 110 identifies either the highest quality version of the content that matches the capability data of at least one network slice, or it identifies the lowest quality version of the content. In S23, the service provider network element 110 sends a message to the first UE 10 including the content identifier, version identifier, and network slice identifier of the identified content/version pair and the highest priority network slice that had a capability data that satisfied the content/version pair's requirement profile.

In S25, the first UE 10 sends an attach request message to the cellular telecommunications network 1, including the network operator identifier and slice identifier of the selected network slice for accessing and consuming the content from the service provider. In response, in S27, the network 1 accepts the request and the first UE 10 establishes a second connection with the network via the selected network slice. In S29, the first UE 10 sends a request message to the service provider network element 110, via the selected network slice, for the item of content. In S31, the service provider network element 110 responds by sending the item of content to the first UE 10, which again will be sent via the identified selected slice.

In the above embodiments, the network slice manager 150 sends, to each base station, the identities of each network slice that base station may use and the capability data for each of those network slices. The base stations then broadcast these slice identities and capability data such that all UEs may receive it. However, this is non-essential. In an alternative implementation, the network slice manager 150 does not transmit this data to the base stations. Instead, the UE, base station and network slice manager may cooperate such that a request message may be sent from the UE to the network slice manager for information on all available network slices (e.g. upon the UE identifying a new service), and the network slice manager may respond with the identities and capability data for the available network slices (e.g. based on that UE's network operator). In this alternative implementation, the request message sent from the UE to the network slice manager may include information on the service (e.g. by identifying the service type), and the network slice manager 150 may then only return the identities and capability data of relevant network slices (e.g. those that are tailored for that particular service). Furthermore, the request message sent from the UE to the network slice manager may include the requirement profile for the service, and the network slice manager 150 may then perform the network slice matching function to identify the network slice that the UE should use to access the service. Accordingly, the matching function may be implemented either in the UE or the network.

Embodiments of the present disclosure may also be implemented in a roaming scenario. That is, when the UE is connected to a base station of a visited network and discovers a new service, it may send a request message to the network slice manager of the visited network including information on the service (e.g. by identifying the service type or including the requirement profile). The network slice manager of the visited network may then forward this request to a network slice manager in the home network, which may then identify one or more network slices for that service that are also available to the UE in the visited network via a roaming agreement between the home and visited networks.

In the above embodiments, the service provider had several requirement profiles and it would select one of these requirement profiles in response to a request from a UE. However, this is non-essential and the service provider may have a single requirement profile. It would, nonetheless, be possible for this requirement profile to be modified (in a similar manner to the second embodiment above) if no suitable match was found between the network slices' capability data and this requirement profile. Furthermore, it is non-essential that the service provider offers a VR application to the end-user. The service provider may provide any form of service using the cellular network, and the corresponding requirement profile(s) may be adapted to match that service.

FIG. 2 and the related description above illustrates how embodiments of the disclosure may be performed upon any networking nodes that are configured for network slicing (regardless of protocol). As noted above, these networking nodes may be implemented on generalized computing hardware (rather than bespoke physical hardware in the prior art). This generalized computing hardware may include, for example, a central processor unit (CPU) communicatively connected to storage and an input/output (I/O) interface via a data bus. Storage can be any read/write storage device such as a random access memory (RAM) or a non-volatile storage device. An example of a non-volatile storage device includes a disk or tape storage device. The I/O interface is an interface to devices for the input or output of data, or for both input and output of data. In this embodiment, the I/O device is a network connection (for connection, for example, to any other node in the cellular network), but may also include a keyboard, a mouse, or a display (such as a monitor). The CPU, storage, I/O interface and data bus cooperate to define a SDN operating environment in which any networking function of a networking node (e.g. UPF, AMF, SMF, etc.) may be implemented as software. In this manner, the computing hardware may be configured to operate as any one of the networking nodes by using the corresponding software. Furthermore, the computing hardware is configured to implement a NFV architecture such that it may implement a plurality of virtual machines, wherein each virtual machine may provide a different SDN operating environment implementing a particular networking function that is optimized for a particular use case (e.g. a particular network operator, a particular service, a particular user, etc.).

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method in a cellular telecommunications network in which one or more network nodes are configured to implement a plurality of network slices, the method comprising:
identifying network slice capability data for a first network slice, the network slice capability data for the first network slice indicating a capability of the first network slice for one or more metrics;
sending the network slice capability data for the first network slice to a service provider;
receiving a message from the service provider permitting access to a version of a service using the first network slice; and
initiating a connection of a User Equipment (UE) to the first network slice for accessing the version of the service.

2. The method as claimed in claim 1, further comprising:
identifying requirement data indicating a network requirement for the one or more metrics for the UE to access the service of the service provider;
identifying network slice capability data for a second network slice, the network slice capability data for the second network slice indicating a capability of the second network slice for the one or more metrics; and
comparing the requirement data to at least one of the network slice capability data for the first network slice or the network slice capability data for the second network slice.

3. The method as claimed in claim 2, wherein the network slice capability data for the first network slice and the second network slice indicates that the first network slice is a higher priority network slice than the second network slice, and the comparing first compares the requirement data to the network slice capability data for the first network slice.

4. The method as claimed in claim 2, wherein the comparing indicates a first matching value between the requirement data and the capability data for the first network slice and a second matching value between the requirement data and the capability data for the second network slice, and the determination is based on the first matching value and the second matching value.

5. The method as claimed in claim 4, wherein the requirement data further indicates a weighting value for the one or more metrics, and the first matching value and the second matching value are further based on the weighting value for the one or more metrics.

6. The method as claimed in claim 2, further comprising:
the UE sending a request message to the service provider for the requirement data; and
the service provider responding to the request message from the UE with the requirement data.

7. The method as claimed in claim 2, wherein the cellular telecommunications network includes a network slice manager, the method further comprising:
the UE sending a request message to the network slice manager for the network slice capability data, the request message identifying a property of the service.

8. The method as claimed in claim 7, wherein the property of the service is the service type, and the method further comprises:
the network slice manager identifying the network slice capability data for the first network slice and the second network slice based on the service type; and
the network slice manager sending a response message to the UE, the response message including the network slice capability data for the first network slice and the second network slice, wherein the UE performs the comparing and the determining based on the network slice capability data for at least one of the first network slice or the second network slice.

9. The method as claimed in claim 7, wherein the property of the service is the requirement data, and the method further comprises:
the network slice manager comparing the requirement data to at least one of the network slice capability data for the first network slice or the network slice capability data for the second network slice;
the network slice manager determining that the UE should access the service using the first network slice based on the comparison; and
the network manager sending a response message to the UE, the response message including an identifier for the first network slice.

10. The method as claimed in claim 1, wherein the service provider includes a requirement profile specifying a network requirement for the one or more metrics for the UE to access a version of the service of the service provider, and the service provider is configured to modify the network requirement for the one or more metrics based on the network capability data for the first network slice.

11. The method as claimed in claim 1, further comprising:
sending the network slice capability data for the second network slice to the service provider.

12. The method as claimed in claim 11, wherein the service provider includes a plurality of requirement profiles, wherein each requirement profile of the plurality of requirement profiles specifies network requirements for the one or more metrics for the UE to access a particular version of the service of the service provider, and the service provider is configured to:
compare the network slice capability data for the first network slice to the plurality of requirement profiles so as to identify a first requirement profile that satisfies the capability data of the first network slice; and
send a message to the UE, the message identifying the version of the service associated with the first requirement profile.

13. The method as claimed in claim 12, further comprising:
comparing the network slice capability data for both the first network slice and the second network slice to the plurality of requirement profiles so as to identify the first requirement profile that satisfies the capability data of the first network slice; and
sending the message to the UE, the message identifying the version of the service associated with the first requirement profile and the first network slice.

14. A computer program product comprising instructions which, when the program is executed by a computer, cause the computer to carry out the method of claim 1.

15. A non-transitory computer-readable data carrier having stored thereon the computer program of claim 14.

16. A device for a cellular telecommunications network, the cellular telecommunications network having one or more network nodes configured to implement a plurality of network slices, the device comprising a transceiver, memory and a processor adapted to cooperate to perform the method of claim 1.

17. The device as claimed in claim 16, wherein the device is a User Equipment (UE).

18. A system comprising a device for a cellular telecommunications network, the cellular telecommunications network having one or more network nodes configured to implement a plurality of network slices, and a network slice manager, the network slice manager having a transceiver, memory and processor adapted to cooperate to perform the method of claim 8.

19. The system as claimed in claim 18, further comprising a service provider having a transceiver, memory and processor including a requirement profile specifying a network requirement for the one or more metrics for the UE to access a version of the service of the service provider, and the service provider is configured to modify the network requirement for the one or more metrics based on the network capability data for the first network slice.

20. A method of providing a service over a cellular telecommunications network, the cellular telecommunications network having one or more network nodes configured to implement a plurality of network slices, the method comprising:
specifying a requirement profile including a network requirement for one or more metrics for a UE to access a version of a service of a service provider;
receiving network slice capability data for a first network slice, the network slice capability data for the first network slice indicating the first network slice's a capability of the first network slice for one or more metrics;
comparing the network slice capability data for the first network slice to the requirement profile; and
sending a message to the UE permitting access to the version of the service using the first network slice.

21. The method as claimed in claim 20, wherein, following receipt of the network slice capability data for the first network slice, the method further comprises modifying the network requirement for the one or more metrics of the requirement profile based on the network capability data for the first network slice.

22. The method as claimed in claim 21, wherein the requirement profile is a first requirement profile of a plurality of requirement profiles, wherein each requirement profile of the plurality of requirement profiles specifies a network requirement for one or more metrics for the UE to access a particular version of the service of the service provider, and the method further comprises:
comparing the network slice capability data for the first network slice to the plurality of requirement profiles; and
identifying that the first requirement profile satisfies the capability data of the first network slice;
wherein the message sent to the UE identifies the version of the service associated with the first requirement profile.

23. The method as claimed in claim 22, further comprising:
receiving network slice capability data for a second network slice, the network slice capability data for the second network slice indicating a capability of the second network slice for one or more metrics;
comparing the network slice capability data for both the first network slice and the second network slice to the plurality of requirement profiles so as to determine that the first requirement profile satisfies the capability data of the first network slice; and
sending the message to the UE, the message identifying the version of the service associated with the first requirement profile and the first network slice.
